(19) United States
(12) Patent Application Publication
(10) Pub. No.: US 2010/0193981 A1
(43) Pub. Date: Aug. 5, 2010

(54) Apparatus and Methods for Interconnecting Tubular Sections

(76) Inventors: Frano Luburic, Anaheim Hills, CA (US); David W. MacDonald, Nova Scotia (CA)

Correspondence Address: MCKENNA LONG & ALDRIDGE LLP, 1900 K STREET, NW, WASHINGTON, DC, 20006, US

(21) Appl. No.: 12/679,311

(22) PCT Filed: Sep. 21, 2007
(86) PCT No.: PCT/US07/79243

§ 371 Date: Mar. 21, 2010

(51) Int. Cl. E04B 1/18; B29C 45/36; B29C 45/14; E04G 13/02

(52) U.S. Cl. 264/32; 264/219; 425/179; 249/48; 249/49

(57) ABSTRACT

Apparatus and methods for multi-piece tubing are disclosed. Optional nestable embodiments (12, 14, 16, and 18) provide benefits in storage, transportation, and use. Optional interlocking elements (30, 32) provide benefits in ease of assembly and use, and possible disassembly, including with other tubing or non-tubing elements such as a base (20). End cover elements (19) can protect tube's interior from undesired dirt, liquid, or other contaminants, and can be removable. Methods include use in forming concrete pier footings or other building supports.

### FIELD OF THE INVENTION

The present invention relates generally to tubular structures, and more specifically to nestable multi-piece tube constructions and related methods for interlocking those pieces into a desired tubular assembly. Among its many applications and uses, the invention can be used in connection with forming concrete footings (such as “pier footings”) for buildings or other structures.

### INCORPORATION BY REFERENCE

The contents of each U.S. patent or other reference, if any, cited in this application, are hereby incorporated by reference.

### SUMMARY OF THE INVENTION

Manufactured tubes and cones have many applications, and can be formed from a wide variety of materials. By forming a tube or cone in multiple pieces that are nestable and easy to assemble with each other (i.e., assembled into a “single” cone/tube), the present invention provides many benefits, including (among others) benefits in manufacture, storage, transportation, assembly, and use.

Among other things, the invention preferably includes a snap-fit interlocking feature between the various pieces, so that no tools are required to assemble the pieces to one another. The invention can also provide a snap-fit or other easy assembly of the tube/cone with other elements (such as differently-shaped structures, like a base structure to support the tube/cone in a desired location and/or orientation).

The invention provides a modular tube/cone, which allows a user to select and use various lengths of pieces and/or numbers of pieces to assemble together, depending on the requirements of a specific job. The preferred modularity/nestability can also provide significant storage and/or transportation/freight savings, because more “tubes” or “cones” can be stored/handled within a given volume, such as on a pallet and/or a truck or other vehicle.

For applications such as construction footings, the invention can also be supplied with a “cap” element to help protect the interior space within the tube. In certain embodiments, such a lid or cap can be positioned at the upper end of the assembly. Among other things, the invention (and the cap elements) can be useful where footing holes have been drilled or otherwise dug into the ground and a base element has been placed into the bottom of the hole with the assembled multi-piece tube/cone attached to it. Prior to pouring concrete into the tube/cone (to form the desired footing for the building or other structure), the top cover or cap preferably remains attached to the assembly in some manner. Among other things, the cover protects the interior of the tube/cone from dirt, rain, etc., that might otherwise fall into it. Later, to permit the insertion of reinforcing steel such as rebar and/or to pour concrete into the footing form, the cap can be removed to “open” the top of the tube/cone. For embodiments fabricated by injection molding or otherwise from plastic or similar material, the cap removal can be accomplished in any suitable manner, such as by cutting it off with a utility knife, using a hammer to “knock-out” or break off the cap along a preformed or weakened breakline, etc.

### BRIEF DESCRIPTION OF THE DRAWINGS

FIG. 1 illustrates a cross-sectional view of a plurality of tubing pieces in accordance with one embodiment of the invention.

FIG. 2A is an exploded perspective view, illustrating how the tubing pieces of FIG. 1 can be separated from each other.

FIG. 2B is an exploded perspective view, illustrating how the tubing pieces of FIG. 2A can then be inverted and reassembled to each other.

FIG. 3 is a sectional view of assembled tubing pieces (similar to FIG. 2B, but showing the pieces actually engaged with other adjacent tubing pieces), further assembled onto a base element.

FIGS. 3A through 3E are enlarged detailed views of the sections shown respectively on FIG. 3 by the corresponding sectioned letters A-A, B-B, C-C, D-D, and E-E.

FIG. 4A is a top view of a base element such as the one shown in FIG. 3.

FIG. 4B is a sectional elevational view of the base element of FIG. 4A, taken through a line running horizontally through the center of FIG. 4A.

FIG. 5 is a perspective view of a base element similar to the one shown in FIGS. 4A and 4B.

FIG. 6 is a detailed view of one of the many alternative embodiments of the invention, similar to FIGS. 3B, 3C, and 3D, showing one of the many alternative structures for engaging the various adjacent elements of the invention.

FIGS. 7A and 7B are perspective views of an embodiment of a plurality of nested tubing elements of the present invention (FIG. 7A) and a corresponding volume of prior art tubing elements (shown in FIG. 7B), illustrating the space savings that can be achieved with certain embodiments of the invention. As shown, for the same volume required for a given number of prior art one-piece tubing devices, the invention allows four times as many nested “tubes” or “cones” to be stored/shipped/etc.

FIG. 8 is similar to FIGS. 10D and 12D as described below, but illustrates the detail in an enlarged view.

FIG. 9 is similar to FIGS. 10C and 12C as described below, but illustrates the detail in an enlarged view.

FIGS. 10 through 10H illustrate another of the many embodiments of a tubing component of the invention. FIG. 10 is a vertical sectional view through the middle of an embodiment of a tubing element such as element 16 in FIGS. 2A and 2B (with element 16 turned horizontally for purposes of taking the section view of FIG. 10). Related detail views are shown as FIGS. 10A through 10H, taken along their respective lines A-A, B-B, C-C, D-D, E-E, F-F, G-G, and H-H shown on that same page in FIG. 10 et seq.

FIGS. 11 through 11H illustrate another of the many embodiments of a tubing component of the invention. FIG. 11 is a vertical sectional view through the middle of an embodiment of a tubing element such as element 16 in FIGS. 2A and 2B (with element 12 turned horizontally for purposes of taking the section view of FIG. 11). Related detail views are shown as FIGS. 11A through 11H, taken along their respective lines A-A, B-B, C-C, D-D, E-E, F-F, G-G, and H-H shown on that same page in FIG. 11 et seq.

FIGS. 12 through 12H illustrate another of the many embodiments of a tubing component of the invention. FIG. 12 is a vertical sectional view through the middle of an embodiment of a tubing element such as element 16 in FIGS. 2A and 2B (with element 18 turned horizontally for purposes of taking the section view of FIG. 11). Related detail views are shown as FIGS. 12A through 12H, taken along their respective lines A-A, B-B, C-C, D-D, E-E, F-F, G-G, and H-H shown on that same page in FIG. 12 et seq.

### DETAILED DESCRIPTION

Embodiments of the present invention will now be described with references to the accompanying Figures, wherein like reference numerals generally refer to like elements throughout. The terminology used in the description presented is not intended to be interpreted in any limited or restrictive manner, simply because it is being utilized in conjunction with a detailed description of certain embodiments of the invention. Furthermore, various embodiments of the invention (whether or not specifically described) may include novel features, no single one of which is solely responsible for its desirable attributes or which is essential to practicing the invention described.

Among other things, the invention provides apparatus and methods relating to a collapsible, nestable tube useful for a broad range of applications. In particular, the invention can be provided in an embodiment that is useful for the construction industry, for use in pouring footings (such as pier footings or others) for buildings or similar structures.

As indicated above, footing holes commonly are drilled or otherwise dug into the ground, positioned at weight-bearing or other strategic locations. In certain prior art systems, a generally conical base element is assembled with a hollow, one-piece tube (made of cardboard or plastic or the like). Normally, the tube is positioned over the top of the base element, and the two are affixed to each other with screws or similar attachments, typically screwed radially through the sidewalls of both the one-piece tube and the base element, toward the center vertical axis of the assembly (toward what eventually will be the center of the tubular concrete footing). The screws hold the one-piece tube to the base, the assembled two parts are positioned specifically into a desired location and orientation, and dirt or sand can be back-filled around the assembly to hold it in place. The top is typically left open, awaiting the eventual pouring of concrete into the interior of the tube assembly.

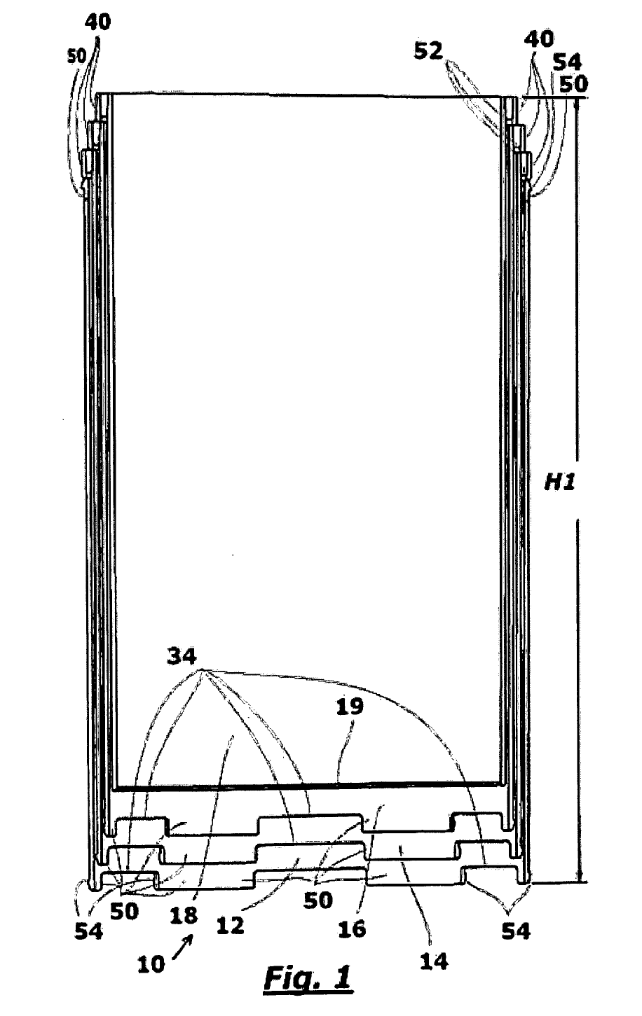

In contrast to that prior art apparatus and process, the present invention provides a modular component type approach to such applications. For a construction application such as the one just described, a plurality of tubing sections 10 (such as elements 12, 14, 16, and 18 in FIG. 1) can be formed in any suitable number, size, diameter, wall thickness, and length. While they may conveniently be fabricated from injection-molded plastic or the like, any suitable materials and fabrication processes may be used. The materials and dimensions selected will depend on the requirements of the particular application for which the invention is to be used.

Design and use and other criteria, including many of the factors discussed herein, can determine the number of tubing components that may be used and/or desirable for a given application. Although FIG. 1 and certain of the other drawings illustrate a tube formed from four tubing components 12, 14, 16, and 18, the invention also can be practiced with fewer or more than four.

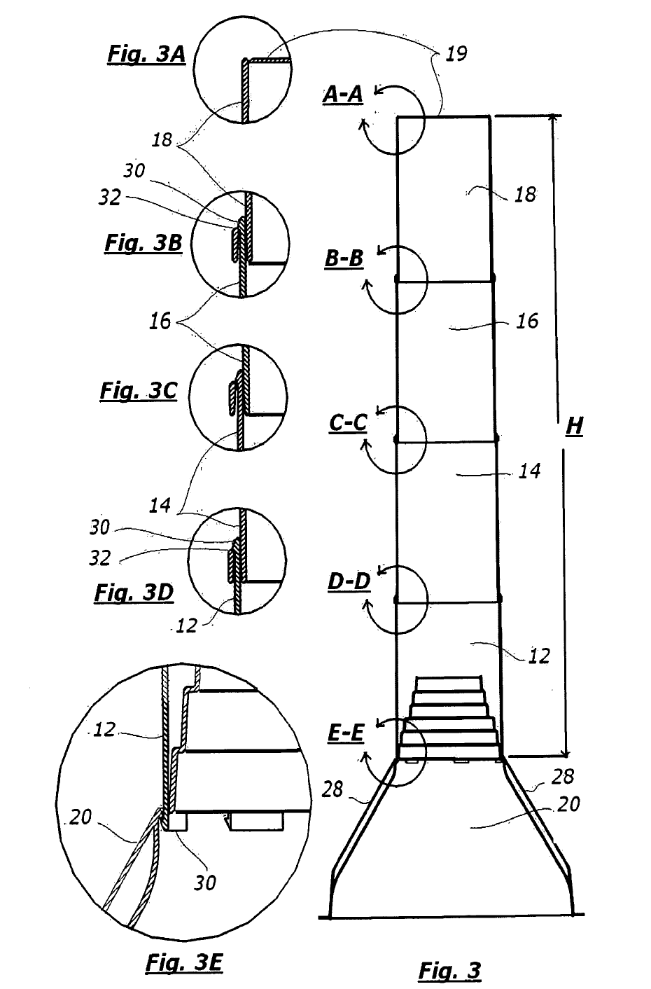

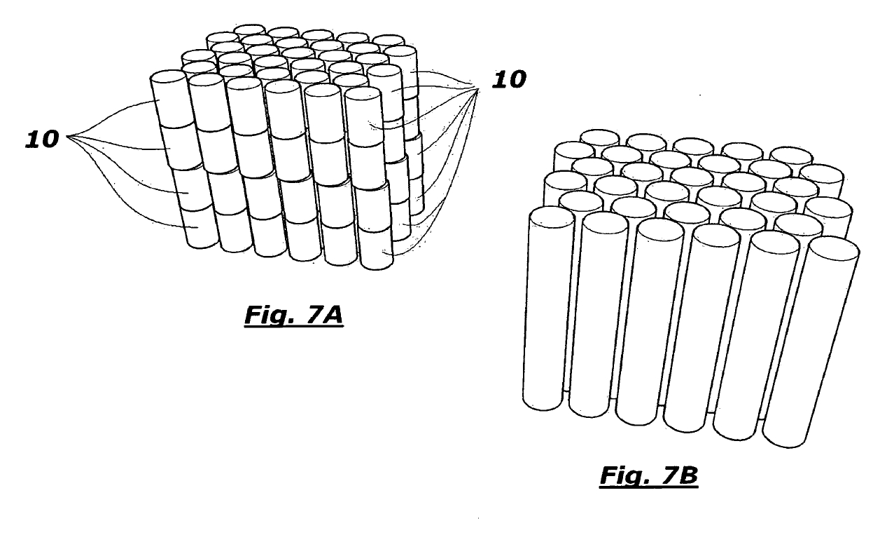

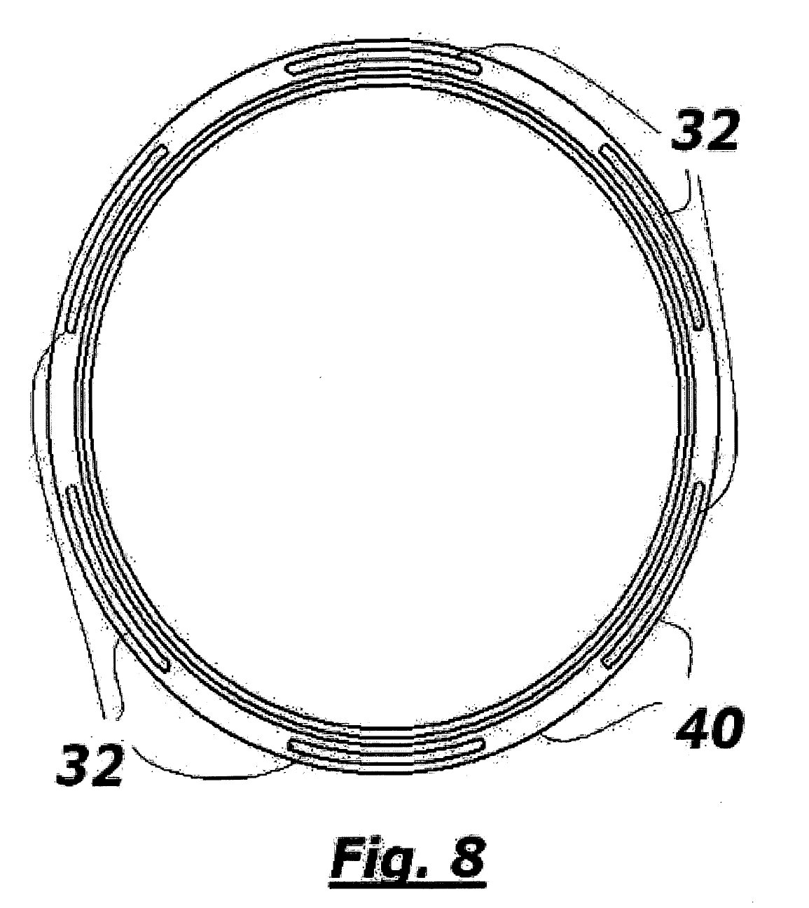

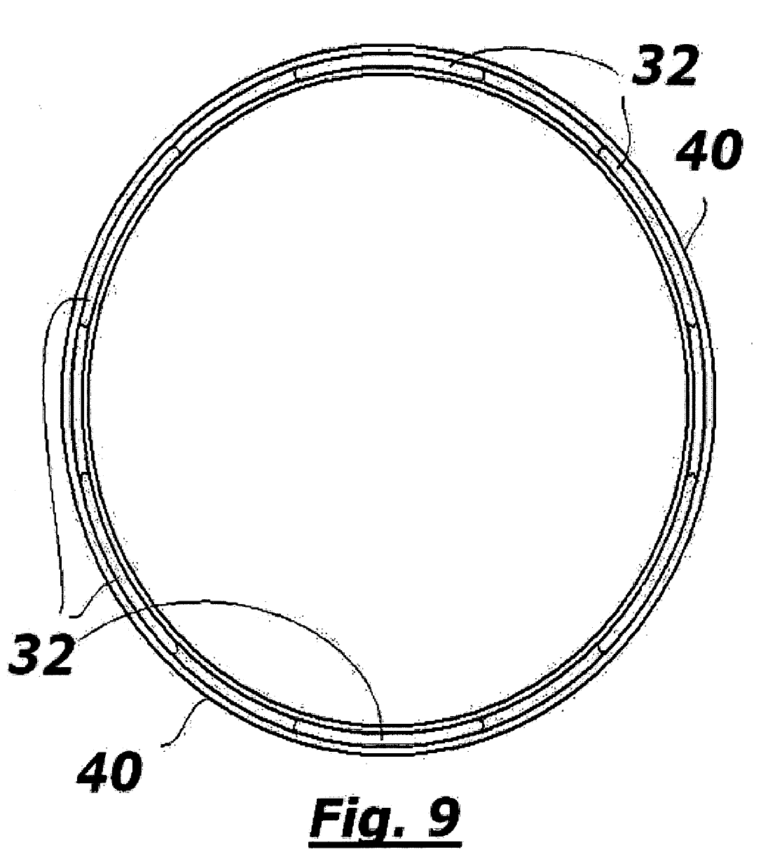

Within a set of tubing components for a given application of the invention (such as a construction footing application as just described), the particular components for the desired final footing form assembly preferably are sized relative to one another to permit them to be nested, as shown in FIG. 1. This nesting relationship can be facilitated by tapering one or more of the respective elements (for example, so that they gradually and uniformly reduce in circumference along their length), sizing various tubing elements within a given “set” so that they interfit nestably, and/or some combination of the two or any other suitable approach. Among other things, embodiments of the invention that include this nesting relationship can permit more economical storage, shipping, and handling of the components prior to assembly (as compared to “single unit” tubes of equivalent volume/shape). For example, an assembled height “H” (see FIG. 3) for a given set of assembled tubing components can be provided by pieces that, when nested together (as in FIG. 1) can be “compacted” into a greatly reduced height “H1” (see FIG. 1). FIGS. 7A and 7B are a visual comparison showing that, for an embodiment of the invention with four nestable pieces that replaces a prior art one-piece tube of similar total length, there is a corresponding increase of four times the “density” that can be achieved during storage, transportation, handling and the like. Other density/height/space reduction ratios can be achieved, depending on the degree of nesting, the number of component parts used “in place of” what might otherwise be a single-piece tubing/cone, and other factors.

The preferred modular nature of the tubing components also facilitates flexible inventory and replacement of damaged parts, easy customization for a particular customer's application, and other benefits. Some embodiments may, for example, include tubing elements that are not of similar length or wall thickness, or may vary in one or more other ways. Depending on the application, the benefits of modularity, storage density, nestability, or other features of the invention may be present in the particular embodiment to varying degrees, even possibly “none” (e.g., a modular tubing application may not have any “nestable” pieces, but still provide other benefits of the invention).

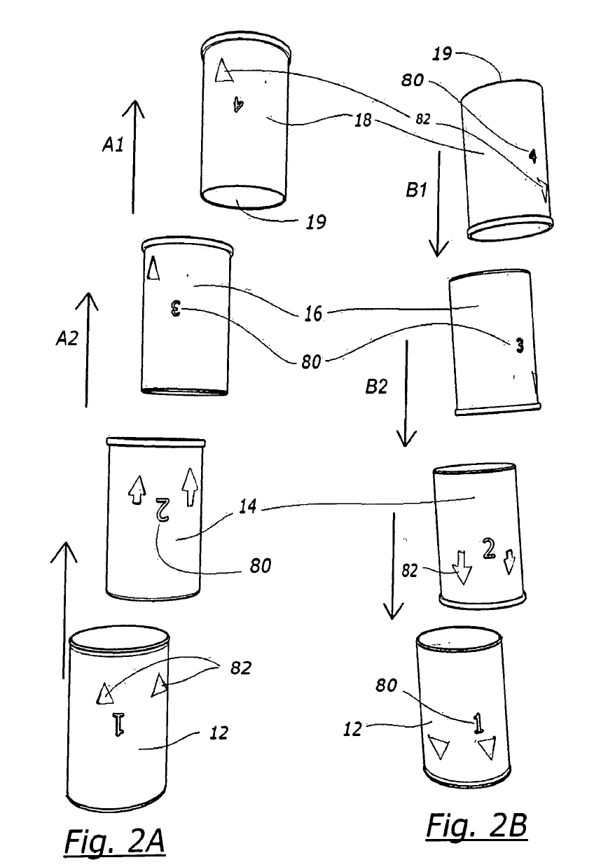

The desirable nesting relationship for certain embodiments of the invention (such as illustrated in FIG. 1) can be accomplished by any suitable means. Among other things, the individual tubing components that make up a given “set” (a group of elements that will eventually be used or usable together with each other within a given application of the invention) can each have a tapering diameter along their respective lengths, so that the narrower end of the component can “nest” into a wider end of an adjacent component for storage/shipping/etc. (as illustrated in FIG. 1), but when the pieces are separated and turned end-for-end (such as illustrated in FIGS. 2A and 2B), the wider ends of each respective piece can engage with the adjacent “next larger” piece into the desired “assembled” relationship. In other words, the nested tubing pieces can be “de-nested” as shown in FIG. 2A (with the arrows A1 and A2 indicating the denesting motion of the pieces relative to each other), and can then be inverted and reassembled to each other as shown in FIG. 2B (the the arrows B1 and B2 indicating the “reassembly” motion of the pieces relative to each other). Such an assembled embodiment is shown in FIG. 3, along with a base element 20 that is also discussed elsewhere herein.

Tapering the various components can provide other benefits as well, including (by way of example) facilitating removal of the molded part from injection-molding tooling.

For embodiments of the invention that use cone pieces or components that are similarly shaped to one another (such as the components 12, 14, 16, 18 in FIGS. 1-3), to more “fully” nest with each other some or all of those components, they each need to be of different sizes, or have a sufficient degree of tapering to permit substantial insertion of one identical part into another, or some combination of those two concepts. If the embodiment does use components of different sizes, those can either have tapered or non-tapered (or generally parallel) diameters. For the latter types of embodiments, the tubing pieces (or some of them) can have “constant” internal/external diameters, for example.

In other embodiments, some or all of the components can be “identical” to one another, having the same tapering diameter/dimensions. Among other things, this can reduce the amount of inventory, tooling, and other overhead required for that application. As noted above, with sufficient tapering, such embodiments can still provide some degree (even a substantial degree) of “nesting”.

In certain embodiments, it is useful to provide a shoulder structure 40 around one end of at least some of the tubing components. In the embodiment of FIG. 1, such a shoulder is shown as part of a channel around one end of each of tubing pieces 14, 16, and 18. Among other things, such peripheral or circumferential shoulders can strengthen the tubing component and/or the eventual assembly of components. For embodiments having a round cross-section, such a shoulder can provide improved hoop strength, which can be helpful for heavy interior pressures or loads such as can result from filling the assembly with concrete, water, or the like.

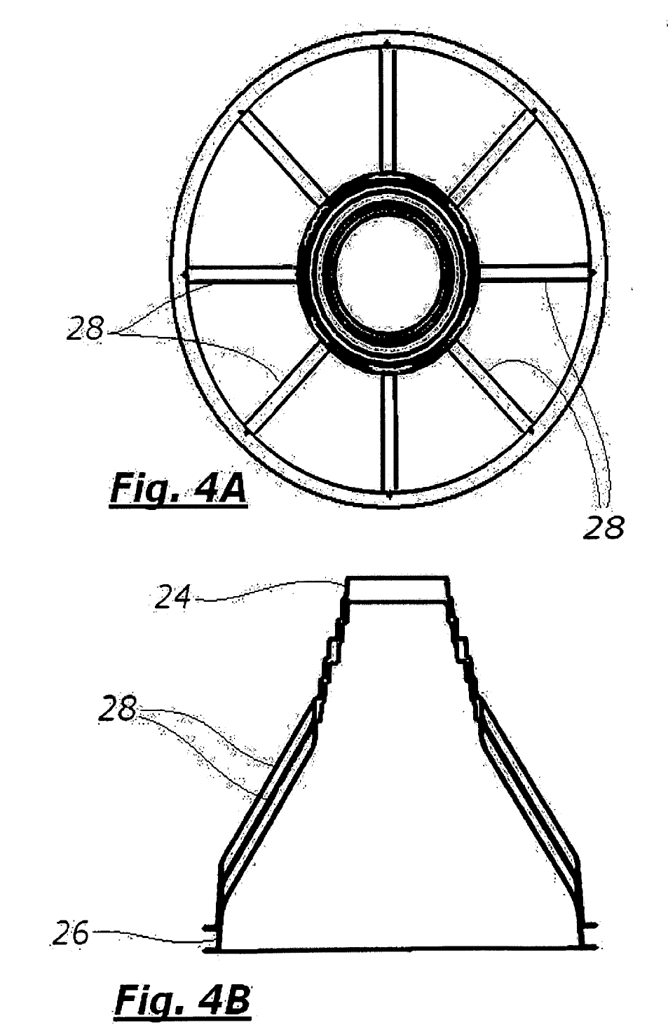

Such a band also can help prevent leaking of fluid (concrete, etc.) from inside the assembly, although other embodiments can achieve a sufficiently leak-tight joint without any such “hoop” or band. If desired, a seal element (not shown) can be disposed within the shoulder area, to help seal the joint between adjacent tubing elements or pieces. A few of the many examples of various ways to achieve such sealing include a hollow gasket or similar seal such as element 110 in FIG. 7 of U.S. Pat. No. 6,604,647, the solid gasket illustrated as abutting the upper inner side of the lid in FIGS. 4-6 of U.S. Pat. No. 5,626,251, and/or the abutting contact between the two pieces being joined shown in FIG. 4 (see element 32 abutting at the arrowhead 30) of U.S. Pat. No. 5,617,968.

Such shoulders or similar structures can also provide an interfering fit between adjacently nested components, to prevent them from sliding completely “through” each other rather than staying nested. Among other things, this “intentional interference” can facilitate easier handling of the components, for example in keeping them in their nested configuration during transportation. In the embodiment of FIG. 1, for example, the shoulders 40 not only are sized in a diameter to eventually receive a mating end of an adjacent tubing piece (as in FIG. 3), but when nested as in FIG. 1, they preferably abut the uppermost edge of the tubing piece in which they are respectively nested. In yet other alternative embodiments (not shown), the “shoulder” element such as peripheral groove or channel 40 can be less than completely around the periphery, and could even be provided by one or more simple detents. For embodiments not having such shoulders, the desirable interfering fit to facilitate nesting can be accomplished some other way, such as by dimensional interference between adjacent nested parts and/or abutment of tapered walls of those parts (similar to the way a stack of certain paper cups can be nested within each other). Yet another of the many approaches to provide nesting embodiments of the invention is a combination of tapered diameters and shoulders.

As indicated above, although certain of the drawings illustrate tubing components having a generally similar diameter and length, the components can vary in those and other dimensions, even within a single “set” of components used in a single application. Similarly, although the drawings illustrate an embodiment of the invention that uses tubing components that have a generally round cross-section, the invention can be practiced with other cross-sections (including by way of example, square, rectangular, triangular, oval, or others). Depending on the application, such different dimensions and/or cross-sections may provide desired or necessary shear strength or other functional or aesthetic benefits, for the tubular assembly itself and/or for any related product (such as a footing or other design or product formed within the assembled tubing shape, from concrete or any other suitable material). Likewise, various factors can be taken into consideration when determining the number of tubing or related elements or components into which a desired footing form or other resulting assembly is to be divided.

To facilitate use in applications such as the construction footing currently under discussion, the tubing components preferably are interconnectable with each other. This permits the pieces to be shipped to a desired location (such as a construction site) in the aforementioned nested relationship. At the use site, the pieces preferably can be separated from their nested relationship (such as illustrated in FIG. 2A), and then connected to one another in some suitable manner (such as illustrated in FIGS. 2B and 3, for example). In one embodiment shown in the drawings, this is accomplished by the provision of one or more mating and interlocking tab or finger elements 50, configured and positioned to be snap-fit into corresponding slots 52 on an adjacent tubing component or other element. Interconnecting means of this type permit ready assembly of the tubing into a desired final configuration, preferably without the need for tools. In contrast to the prior art system described above (using screws to hold a single piece tube to a base), in such an embodiment of the current invention no screws have to be inserted to hold together the pieces. In the embodiment shown in the drawings, the tabs or fingers are somewhat flexible or deformable and have material memory that tends to return them to their original configuration. For insertion or assembly of two adjacent pieces to each other, the tabs 50 are temporarily deformed or pushed out of their normal alignment to allow them to pass through the related openings 52 (tapered leading edges can be provided on the tabs 50 to help facilitate this insertion). Once fully seated through the corresponding opening 52, the tab or tabs 50 preferably spring back to their normal position, causing engagement of a detent 54 on the other side of the slot 52 (the side opposite that from which the tab 50 began being inserted), holding the two joined tubing pieces or other parts to each other in a desired relationship.

Where useful, such interlocking tabs 50 or similar elements can be provided on opposing ends of certain tubing elements (see tubing element 12, for example), slots or openings can be provided on both ends, a mix of each provided on both ends, and/or one or more tabs provided on one end (with no slots/openings) and one or more slots or openings (with no tabs) on the other end (the latter being illustrated as elements 14 and 16 in the current drawings). Among the many alternatives for practicing the invention, the tubing elements can be glued or welded/melted to each other to form a desired assembled configuration, or can be joined in any suitable manner that will meet the demands of the particular application for which the invention is being used.

If necessary, in certain embodiments the tubing components can even be disassembled, such as by disengaging the tabs/fingers 50 from their respective slots 52. For embodiments such as that just described, the flexible fingers/tabs 50 can be deformed back out of interfering engagement with the corresponding slots or openings 52, so that the interfering detent 54 no longer engages the opposite side of the slot/opening. With the detent disengaged in that manner, the two pieces can be separated from each other.

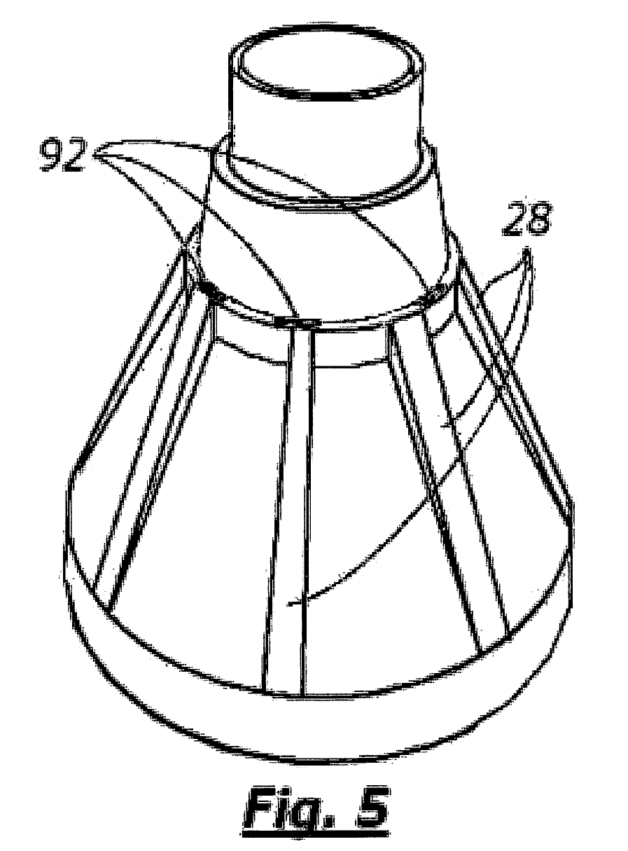

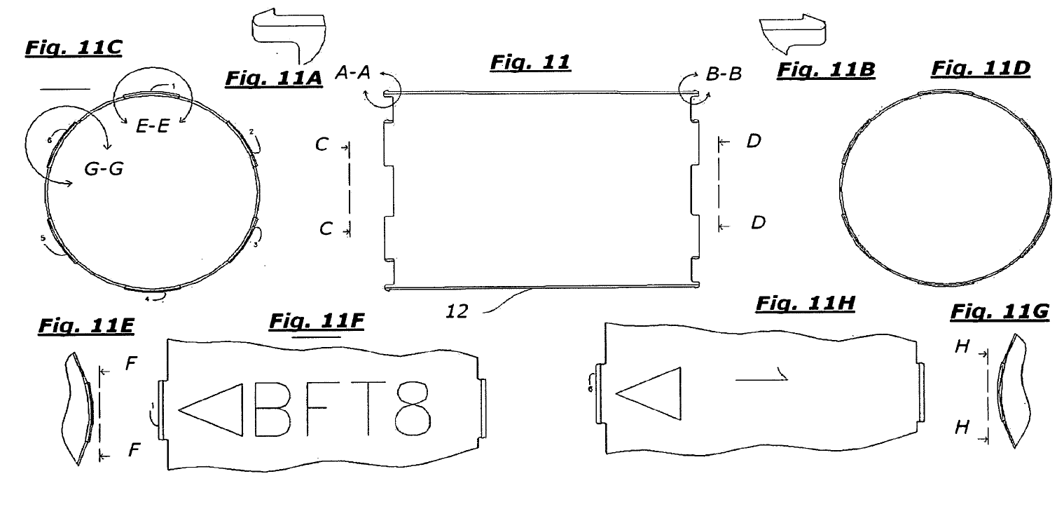

In addition to the desirable interconnectability to each other, the tubing components can be connected to other elements. For applications such as the construction footing mentioned above, this can include connection by similar tab/opening mating elements. Within a given modular component system, a single set of tabs 50 and/or slots 52 can be configured to mate with any of a selection of other elements, including other tubing or non-tubing elements. In a base element such as illustrated in FIG. 5, for example, one or more slots 92 can be formed or otherwise provided at a position or positions to matingly receive a corresponding tab or tabs associated with a tubing cone section (such as section 12 of FIGS. 1-3 or FIGS. 11-11H). Examples of such tabs inserted through such slots are shown as tabs 30 in FIG. 3E.

For embodiments of the invention that use interconnecting tabs and slots, those slots can be provided within or otherwise associated with the aforementioned peripheral shoulder structure or channel 40 and/or the associated tongue 56 and groove 58, as explained below.

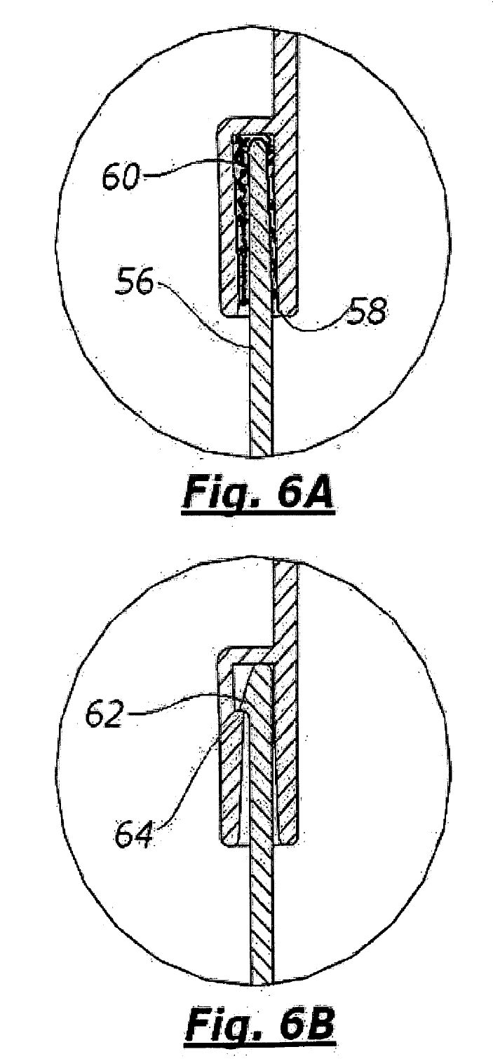

For extra strength in engaging adjacent tubing components, the shoulder 40 can include and/or comprise a tongue-and-groove or similar interengagement for adjacent components. FIG. 6A illustrates one of the many alternative embodiments of the invention, in which a tongue 56 can be formed as some or all of the peripheral edge of one of the tubing elements 10, and a corresponding groove 58 can be configured to receive that tongue 56. As indicated above, the tongue-and-groove can extend partially or completely around the periphery of the tubing component, and can be used with or without the interlocking tabs/slots discussed elsewhere. For example, for a relatively more permanent assembly of adjacent components (and with or without interlocking tabs/slots), a user can apply a suitable glue 60 or other adhesive within the mating “groove” portion 58 prior to inserting the “tongue” 56. In addition or instead of such an adhesive, the tongue-and-groove itself can be dimensioned to be a sufficiently snug fit so that, when assembled with an adjacent tubing component, the parts will tend to stay desirably engaged. Another of the many interlocking approaches for adjacent components is illustrated in FIG. 6B, and would include providing a detent 62 around some or all of the sidewall itself near the “tongue” end, rather than having a detent formed on extending tab portions. A corresponding interfering detent 64 can be formed or provided within the “groove” side 58 of the engagement structure, thereby providing a potentially even more secure generally peripheral or circumferential snap fit interference and interlocking between adjacent components.

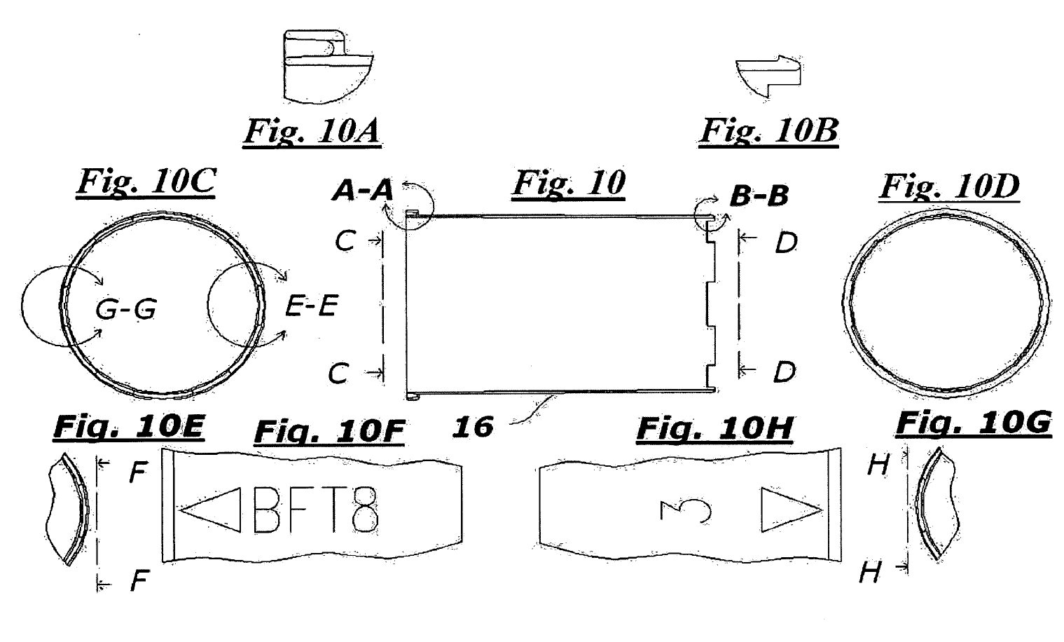

Among the many alternative embodiments of the invention, the “plurality of tabs 50” embodiments (such as shown in FIGS. 1, 10, 11, and 12, for example) can be described as being “modified” versions of “peripheral tab/detent” embodiments such as the peripheral one 62 illustrated in FIG. 6B. For example, such a “peripheral” tab/detent as shown in FIG. 6B can be modified (by cutting out or otherwise originally forming, etc.) to include “gaps” or spaces such as spaces 34 (see FIG. 1), with the “remaining” one or more portions of the “peripheral tab/detent” constituting the engagement “tabs”.

Depending on the application, such “tab” embodiments can be used and engaged with parts having the same “full perimeter/peripheral” channel that is used for the “full perimeter/peripheral tab”. In other words, in certain embodiments, the “same” channel can be configured to alternatively receive “full periphery” or one or more “tabs”. If, in such embodiments, the cross-sectional shape of the tubing pieces and/or joint have some symmetry (such as being round), the orientation of the two tubing or other elements with respect to one another as they are being joined to each other can be less critical. In other words, assembly of such embodiments can be even easier than in other embodiments, because the tabs can fit in multiple places within the channel instead of having to align with and be inserted into and/or through a particular slot or, indeed, through any slot at all.

In addition, as mentioned above, a seal can be provided in alternative embodiments, within the channel 40 or otherwise. A few of the many types of seals are described above (a hollow gasket or similar seal such as in U.S. Pat. No. 6,604,647, a solid gasket such as in U.S. Pat. No. 5,626,251, and/or abutting contact such as shown in U.S. Pat. No. 5,617,968). Among other things, such seals can be liquid-tight (or not) or even air-tight. They can seal against leakage from the inside of the assembly, from the outside of the assembly, and/or both. Such a seal can be provided in any suitable manner and form (including, by way of example and not by way of limitation) multiple pieces, injected seal material, a sealing ring or gasket, etc.), and can be removable or relatively more permanent.

If the components need to be disengaged from each other at some point thereafter, a tearstrip element (not shown) can even be formed around or otherwise near the joint (such as by forming a tearline into the plastic sidewall), to permit a user to grip a tab and pull that strip and the detent attached to it out of engagement from the other detent. Examples of tearstrips are illustrated in some of the patents mentioned above.

Within the attached exemplary Figures are details of certain embodiments of the invention that utilize corresponding tongues/grooves/tabs/slots. The dimensions of those elements, as well as the number and location of the tabs/slots can be any of a wide variety. The selection of such dimensions, spacing, and the like can affect the integrity and/or strength of the resulting joint between the components, can facilitate stacking and/or nesting, and can have other costs/benefits. For example, the slots 52 can be oversized (wider and/or longer peripherally) than the corresponding tabs 50. Among other things, this can make it easier to orient and align the components with respect to each other when assembling them.

Combinations of the foregoing and other components likewise can be used where desirable in certain embodiments.

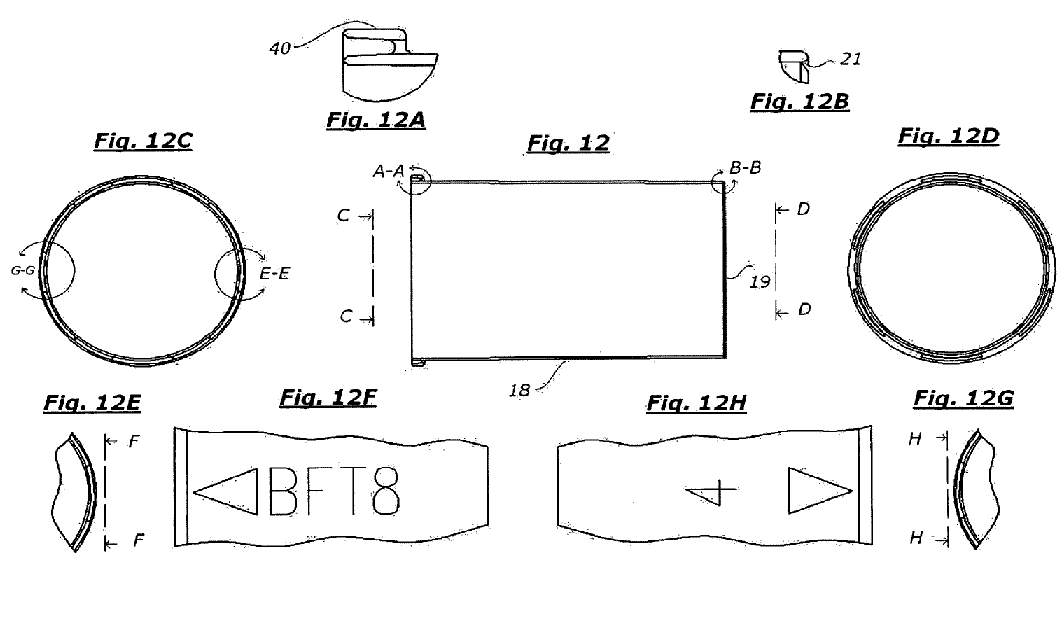

For certain applications and embodiments of the invention (such as for the foregoing construction footing situation), an additional feature of the invention can be provided: a cap or cover element 19. Although such a cap 19 can be provided as a separate removable sleeve (not shown), it is convenient for certain applications to integrally mold an end cap or the like onto one end of one or more of the tubing elements (for example, see tubing piece 18). For applications such as the construction footing discussed herein, the cap 19 preferably is positioned to seal the top of the assembled tubing footing form, and remains in place until such time or times as it needs to be removed to allow insertion of rebar and/or pouring of concrete into the form. The removal can be by any convenient means, including, by way of example, cutting the cap off using a box-knife or similar tool, using a hammer or similar tool to break off the cap, etc. To facilitate the cap's removal, a weakened breakline 21 (see FIG. 12B, for example) can be formed or otherwise provided around the cap. Among other things, the cap 19 can help keep dirt, rain, or other undesirable things out of the form's interior, thereby improving the quality of the footing that eventually will be poured/formed.

To facilitate assembly of the tubing components in certain applications (for example, where the components are intended to be positioned in a certain direction and/or order), the parts can be numbered sequentially (as with numbers 80) or otherwise labeled, and arrows 82 or other indicia can be provided to indicate the direction of “assembled” orientation for the specific part. For embodiments in which the parts are fabricated by injection molding or similar process, the numbering or other markings can be engraved into the part. Examples of such engraving or other indicia are illustrated in FIGS. 2A and 2B. Among the many alternatives for such labeling are stickers or other labels, stamps or other ink/marking applied after the parts are formed, and the like.

As discussed above, among the many applications of the invention is the apparatus and methods for using a multi-piece tube/cone for a concrete footing form. The tube can be attached to a base element 20 by any suitable means (including without limitation the tongue/groove/glue/tab/slot approaches described above), and prior to pouring concrete into the tube/cone (to form the desired footing for the building or other structure), a top cover or cap 19 on the assembly can remain attached to the assembly in some manner. To permit the subsequent insertion of reinforcing steel such as rebar and/or to pour concrete into the footing form, the cap 19 can be removed to “open” the top of the tube/cone form.

Other “non-tubing” elements such as the base element 20 can themselves be nestable (see for example, FIG. 4B, showing two such elements nested together prior to assembly with tubing elements (base 26 is nested within similarly sized and shaped base 24). As shown in FIGS. 3, 4A, and 4B, various reinforcing ribs 28 can be provided as needed.

Thus, the invention provides, among other things, a system of nestable tube pieces that can be assembled end-to-end to form a longer tube. A preferred snap-fit interlock can facilitate ready assembly of the various components into a desired final configuration.

Although the methods of the present invention have been described with steps occurring in a certain order, the specific order of the steps, or any continuation or interruption between steps, is not necessarily required. Moreover, the apparatus and methods of the present invention have been described with some particularity, but the specific designs, constructions and steps disclosed are not to be taken as delimiting of the invention. Modifications will make themselves apparent and will not depart from the essence of the invention, and all such changes and modifications are intended to be encompassed within the appended claims.

1. Apparatus for forming a concrete pier footing, comprising:
a plurality of tubing elements, and
structures for interconnecting said tubing elements into a desired form, said
form including at least one opening for receiving concrete into a space within the form.

2. The apparatus of claim 1, said tubing elements being nestable with each other prior to said assembly into said desired form.

3. The apparatus of claim 1, further comprising at least one removable cover element, said cover element cooperating with said form to protect said space within the form prior to removal of the cover.

4. The apparatus of claim 1, further comprising at least one non-tubing element to which said tubing elements are connected.

5. A method of forming a concrete pier footing, comprising the steps of:
providing the apparatus of claim 1;
assembling the elements to one another into the desired form using the interconnecting structures;
positioning the apparatus in a desired location;
removing any cover element; and
pouring concrete into said space within the form.

6. A method of forming a tube, comprising the steps of:
providing a plurality of nested tubing elements;
providing interconnecting means for assembling the tubing elements to each other to form a desired shape;
de-nesting the tubing elements from each other; and
assembling the tubing elements to each other to form a desired shape, using the interconnecting means.

7. Apparatus for forming a tube, comprising:
a plurality of similarly-shaped tubing elements having integral cooperating engagement elements for connecting adjacent elements to each other, said cooperating engagement elements comprising at least one tab element and at least one cooperating slot to receive said tab.

8. The apparatus of claim 7, in which said tab element includes at least one detent thereon, said tab element and said slot configured to permit said tab and its detent to pass through said slot into an engaged position, and said detent positioned to avoid subsequent inadvertent dislodgment of said tubing elements from said engaged configuration.

9. Apparatus for forming a tube, comprising:
a plurality of similarly-shaped, nestable tubing elements; at least one such element having a protruding tongue portion formed at at least one end, at least one other of said tubing elements including a groove portion formed at at least one end, said tongue and groove portions sized and configured to interengage with each other.

10. The apparatus of claim 9, further comprising cooperating detent structures acting between said tongue and groove to hold adjacent ones of said tubing elements in an interengaged relationship.

11. The apparatus of claim 9, further comprising at least one tab element on said tongue and at least one cooperating slot in said groove for receiving said tab element, said tab including a detent, said tab element and said slot configured to permit said tab and its detent to pass through said slot into an engaged position, and said detent positioned to avoid subsequent inadvertent dislodgment of said tubing elements from said engaged configuration.

12. The apparatus of claim 9, further comprising integral cooperating engagement elements for connecting adjacent tubing elements to each other, said cooperating engagement elements comprising at least one tab element and at least one cooperating slot to receive said tab.

13. Apparatus for injection molding the apparatus of claim 1, comprising a plurality of mold elements configured to receive material and form it into said tubing elements.
